(19) United States
(12) Patent Application Publication
(10) Pub. No.: US 2022/0417623 A1
(43) Pub. Date: Dec. 29, 2022

(54) DATA MANAGEMENT APPARATUS, SENSOR APPARATUS, DATA MANAGEMENT METHOD, AND NON-TRANSITORY COMPUTER READABLE MEDIUM

(71) Applicant: NEC Corparation, Minato-ku, Tokyo (JP)

(72) Inventors: Manaka YAJIMA, Tokyo (JP); Daisuka Nakayama, Tokyo (JP); Yukiko Nakayama, Tokyo (JP)

(73) Assignee: NEC Corparation, Minato-ku, Tokyo (JP)

(21) Appl. No.: 17/787,661

(22) PCT Filed: Dec. 27, 2019
(86) PCT No.: PCT/JP2019/051517

§ 371 Date: Jun. 21, 2022

(51) Int. Cl. H04Q 9/00; G01D 9/00

(52) U.S. Cl. CPC H04Q 9/00; G01D 9/005; G06Q 50/26

(57) ABSTRACT

A data management apparatus (20) includes a data acquisition unit (210), a municipality information generation unit (220), and a storage processing unit (230). The data acquisition unit (210) acquires data generated by a sensor apparatus installed along a road in association with sensor identification information capable of identifying the sensor apparatus. The municipality information generation unit (220) generates, by using the sensor identification information, municipality information indicating a municipality that manages a location where the sensor apparatus is installed. The storage processing unit (230) stores the data acquired by the data acquisition unit (210) in a data storage unit (232) in association with the municipality information generated by the municipality information generation unit (220).

### TECHNICAL FIELD

The present invention relates to a data management apparatus, a sensor apparatus, a data management method, and a program.

### BACKGROUND ART

In recent years, it has been studied that sensors are installed in various locations and data are collected from these sensors. Patent Document 1, for example, describes that various types of sensors are installed in a streetlight and a traffic signal and data are collected from these sensors.

### RELATED DOCUMENT

### [Patent Document]

[Patent Document 1] Japanese Patent Application Publication No. 2014-209311

### DISCLOSURE OF THE INVENTION

### Technical Problem

The present inventor has studied that sensors are installed along a road and data generated by these sensors are efficiently managed. One object of the present invention is to efficiently manage data generated by a sensor installed along a road.

### Solution to Problem

According to the present invention, provided is a data management apparatus including:

a data acquisition unit that acquires data generated by a sensor apparatus installed along a road in association with sensor identification information capable of identifying the sensor apparatus;

a municipality information generation unit that generates, by using the sensor identification information, municipality information indicating a municipality that manages a location where the sensor apparatus is installed; and

a storage processing unit that stores the data in a storage unit in association with the municipality information.

According to the present invention, provided is a sensor apparatus installed along a road, the sensor apparatus including:

at least one type of a sensor; and

a communication unit that transmits data generated by the sensor in association with municipality information indicating a municipality that manages a location where the data transmission apparatus is installed.

According to the present invention, provided is a data management method including:

by a computer,

acquiring data generated by a sensor apparatus installed along a road in association with sensor identification information capable of identifying the sensor apparatus;

generating, by using the sensor identification information, municipality information indicating a municipality that manages a location where the sensor apparatus is installed; and

storing the data in a storage unit in association with the municipality information.

According to the present invention, provided is a program for causing a computer to include:

a function of acquiring data generated by a sensor apparatus installed along a road in association with sensor identification information capable of identifying the sensor apparatus;

a function of generating, by using the sensor identification information, municipality information indicating a municipality that manages a location where the sensor apparatus is installed; and

a function of storing the data in a storage unit in association with the municipality information.

### Advantageous Effects of Invention

According to the present invention, data generated by a sensor installed along a road are efficiently managed.

### BRIEF DESCRIPTION OF THE DRAWINGS

The above-described object, other objects, features, and advantages will become more apparent from a preferred example embodiment described below and the following accompanying drawings.

FIG. 1 is a diagram for illustrating a usage environment of a data management apparatus according to an example embodiment.

FIG. 2 is a diagram illustrating one example of a sensor apparatus.

FIG. 3 is a diagram illustrating one example of a function configuration of the data management apparatus.

FIG. 4 is a diagram illustrating, based on a table format, one example of a data configuration of a sensor location storage unit.

FIG. 5 is a diagram illustrating, based on a table format, one example of a data configuration of a data storage unit.

FIG. 6 is a diagram illustrating a hardware configuration example of the data management apparatus.

FIG. 7 is a flowchart illustrating a first example of processing executed by the data management apparatus.

FIG. 8 is a flowchart illustrating a modification example of FIG. 7.

FIG. 9 is a flowchart illustrating a second example of processing executed by the data management apparatus.

FIG. 10 is a flowchart illustrating a first example of step S120 in FIG. 9.

FIG. 11 is a flowchart illustrating a second example of step S120 in FIG. 9.

### DESCRIPTION OF EMBODIMENTS

Hereinafter, an example embodiment according to the present invention is described by using the accompanying drawings. Note that in all drawings, a similar component is assigned with a similar reference sign and description thereof is omitted as appropriate.

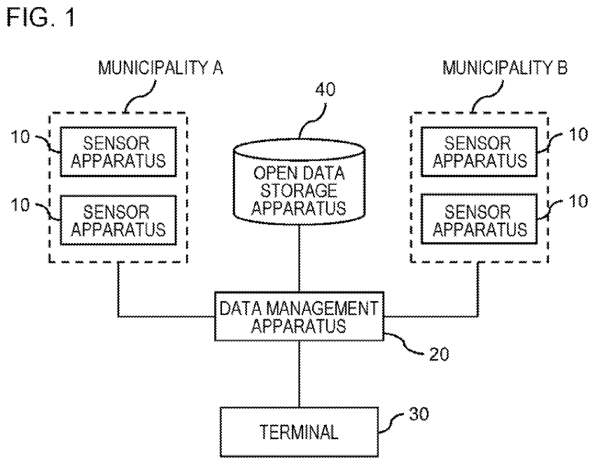

FIG. 1 is a diagram for illustrating a usage environment of a data management apparatus 20 according to an example embodiment. The data management apparatus 20 is an apparatus that manages data generated by a plurality of sensor apparatuses 10.

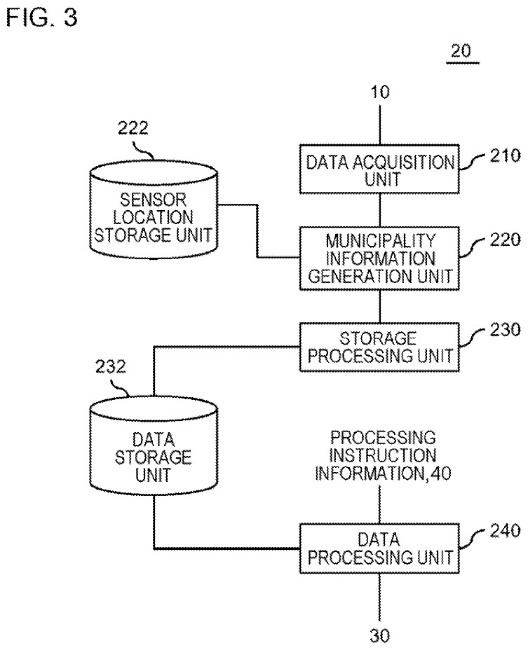

A plurality of sensor apparatuses 10 are disposed along a road. However, the sensor apparatuses 10 are disposed in various locations. Some sensor apparatuses 10 are installed in a location managed by a first municipality (hereinafter, referred to as a municipality A), and some other sensor apparatuses 10 are installed in a location managed by a second municipality (hereinafter, referred to as a municipality B). Then, in the locations managed by both municipalities, a plurality of sensor apparatuses 10 are disposed. The data management apparatus 20 stores data generated by a sensor apparatus 10 in a storage unit (specifically, a data storage unit 232 illustrated in FIG. 3) in association with a municipality relevant to an installation location of the sensor apparatus 10.

Further, the data management apparatus 20 processes data acquired from the sensor apparatus 10. An example of processing executed herein is described later. Further, the data management apparatus 20 may execute processing by using data relevant to a plurality of municipalities. Further, the data management apparatus 20 may execute processing by using, in addition to data acquired from the sensor apparatus 10, data stored in an open data storage apparatus 40. Data stored in the open data storage apparatus 40 are commonly available. As one example. the open data storage apparatus 40 is meteorological data, data relating to a water level of a river or a dam, or the like.

The data management apparatus 20 outputs a processing result of data to a terminal 30. A user or a manager of the terminal 30 may be a municipality, or the terminal 30 may be managed by a private company, a corporation, or an individual. When a manager of the terminal 30 is a municipality, the municipality may be a municipality of a location where a sensor apparatus 10 being a generation source of data to be processed is installed or another municipality.

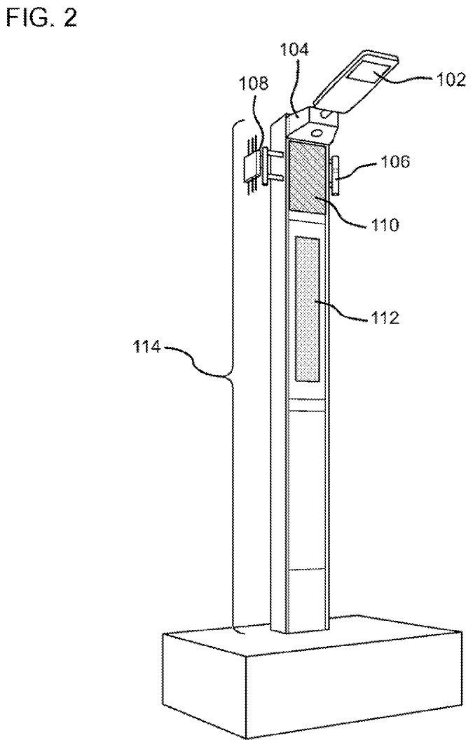

FIG. 2 is a diagram illustrating one example of the sensor apparatus 10. In an example illustrated in the present figure, the sensor apparatus 10 doubles as a streetlight (a light along a street). The sensor apparatus 10 may be disposed along a road in a residential street, may be disposed along a road where a traffic lane and a sideway are separated, for example, along a main road, or may be disposed along a road dedicated to automobiles, for example, along an expressway. The sensor apparatus 10 includes a light source 102 such as an LED, an image capture unit 104, a sensor group 106, a communication unit 108, a speaker 110, and a display 112.

The image capture unit 104 and the sensor group 106 each are one example of a sensor provided for the sensor apparatus 10, and are installed in an upper portion of a supporting pillar 114. Further, the sensor group 106 includes at least an illuminance sensor, a temperature sensor, a humidity sensor, a vibration sensor, and an inclination sensor.

The image capture unit 104 covers, as an image capture region, a region viewable when looked downward from an upper portion of the supporting pillar 114, i.e., a road where the sensor apparatus 10 is installed. Therefore, the supporting pillar 114 can capture an image of a moving object, for example, a person, a bicycle, and a vehicle, passing through a road where the sensor apparatus 10 is installed. In the example illustrated in the present figure, the image capture unit 104 is located in a vicinity of the light source 102, for example, in a portion where the light source 102 is attached to the supporting pillar 114. By doing so, when an amount of light of natural light is insufficient, for example, at night or the like, the light source 102 can double as a light source of the image capture unit 104.

An image generated by the image capture unit 104 and various types of data generated by the sensor group 106 (hereinafter, referred to as data generated by the sensor apparatus 10) are transmitted to the data management apparatus 20 by the communication unit 108, together with information (hereinafter, referred to as sensor identification information) capable of identifying the sensor apparatus 10. The sensor identification information may include information indicating a municipality of a location where the sensor apparatus 10 is installed (e.g., a municipality name: one example of municipality information described later). The communication unit 108 is, for example, a wireless communication apparatus but may be a wired communication apparatus. Further, the sensor identification information is, for example, a sensor ID uniquely allocated to each sensor apparatus 10. The sensor identification information is stored, for example, in the communication unit 108.

Further, an image generated by the image capture unit 104 and various types of data generated by the sensor group 106 are transmitted to the data management apparatus 20 in association with information (hereinafter, referred to as type information) indicating a type of a sensor having generated the data and a generation time and date of the data.

Herein, the sensor apparatus 10 may execute predetermined processing (e.g., compression processing of data) for an image and/or data, and then transmit the processed image and/or data to the data management apparatus 20.

However, the sensor apparatus 10 does not necessarily double as a streetlight. In this case, the sensor apparatus 10 includes at least the image capture unit 104, the sensor group 106, and the communication unit 108, and is preferably attachable to a supporting pillar of a streetlight already installed.

FIG. 3 is a diagram illustrating one example of a function configuration of the data management apparatus 20. In the example illustrated in the present figure, the data management apparatus 20 includes a data acquisition unit 210, a municipality information generation unit 220, and a storage processing unit 230. The data acquisition unit 210 acquires, from the sensor apparatus 10, data and sensor identification information. The municipality information generation unit 220 generates, by using the sensor identification information, information (hereinafter, referred to as municipality information) indicating a municipality that manages a location where the sensor apparatus 10 is installed. The storage processing unit 230 stores the data acquired by the data acquisition unit 210 in the data storage unit 232 in association with municipality information. The data storage unit 232 may be a part of the data management apparatus 20, or may be located outside the data management apparatus 20.

Note that, information acquired by the data acquisition unit 210 further includes type information of a sensor having generated data and a generation time and date. The storage processing unit 230 stores data generated by a sensor of the sensor apparatus 10 in the data storage unit 232 in association with type information and a generation time and date relevant to the data.

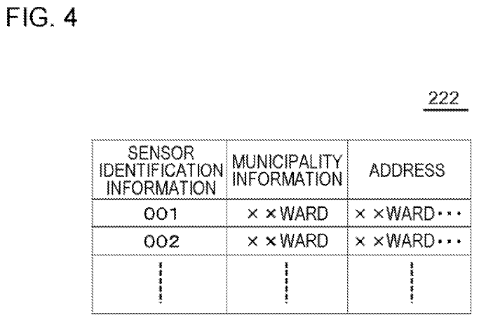

In the example illustrated in the present figure, the municipality information generation unit 220 generates municipality information by using information stored in a sensor location storage unit 222. An example of the processing is described later by using FIG. 4. Note that, the sensor location storage unit 222 may be a part of the data management apparatus 20, or may be located outside the data management apparatus 20.

The data management apparatus 20 further includes a data processing unit 240. The data processing unit 240 processes data stored in the data storage unit 232, and outputs a processing result to the terminal 30. At that time, the data processing unit 240 also uses, as necessary, information stored in the open data storage apparatus 40. The data processing unit 240 acquires, for example, processing instruction information from an outside. The processing instruction information includes information specifying data to be processed, information indicating a processing method (e.g., a type of statistical processing, a format of output data, and the like) for data, and information specifying the terminal 30 being an output destination. An example of processing executed by the data processing unit 240 is described later by using a flowchart.

Processing instruction information described above is generated, for example, based on a contract between a manager of the terminal 30 and a manager of the data management apparatus 20. At that time, the terminal 30 pays a consideration, but the consideration is divided between a municipality of which the sensor apparatus 10 being a processing target is installed and the manager of the data management apparatus 20. At that time, a ratio of the consideration paid to the municipality is defined based on a contract. Then, the data management apparatus 20 may compute the consideration. A flow of a consideration includes, for example, two types described below.

In a first example, a manager of the terminal 30 pays a consideration to a manager of the data management apparatus 20. Thereafter, the manager of the data management apparatus 20 pays a predetermined ratio of the paid consideration to a municipality.

On the other hand, in a second example, a manager of the terminal 30 pays a consideration to a municipality. Thereafter, the municipality pays a predetermined ratio of the paid consideration to a manager of the data management apparatus 20.

The data processing unit 240 may include a storage unit that stores a processing result. In this case, the data processing unit 240 reads, when receiving a request for a processing result from the terminal 30, a processing result stored in the storage unit and outputs the read processing result to the terminal 30.

FIG. 4 is a diagram illustrating, based on a table format, one example of a data configuration of the sensor location storage unit 222. In the example illustrated in the present figure, the sensor location storage unit 222 stores, with respect to each piece of sensor identification information (e.g., a sensor ID), an address of a location where a sensor apparatus 10 relevant to the sensor identification information is installed, and municipality information of a municipality that manages the location. Then, the municipality information generation unit 220 of the data management apparatus 20 reads, from the sensor location storage unit 222, municipality information and an address relevant to the sensor identification information.

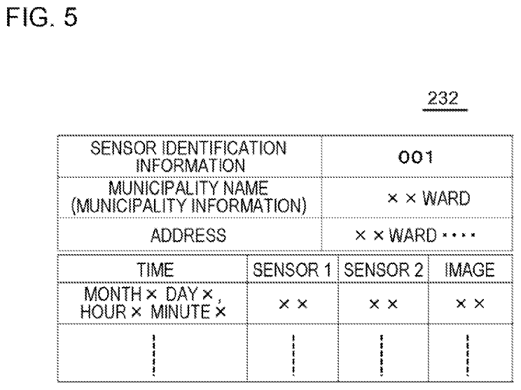

FIG. 5 is a diagram illustrating, based on a table format, one example of a data configuration of the data storage unit 232. In the example illustrated in the present figure, the data storage unit 232 stores data, with respect to each piece of sensor identification information. As one example, the data storage unit 232 stores, with respect to each generation time of data, a plurality of pieces of data (e.g., an illuminance, a temperature, humidity, a vibration, an inclination, and an image) generated by the sensor apparatus 10.

Note that, in the example illustrated in the present figure, the data storage unit 232 stores information (an address and municipality information) indicating an installation location of the sensor apparatus 10, but may not necessarily store these pieces of information. Further, the data storage unit 232 may store, as necessary, data acquired from the open data storage apparatus 40.

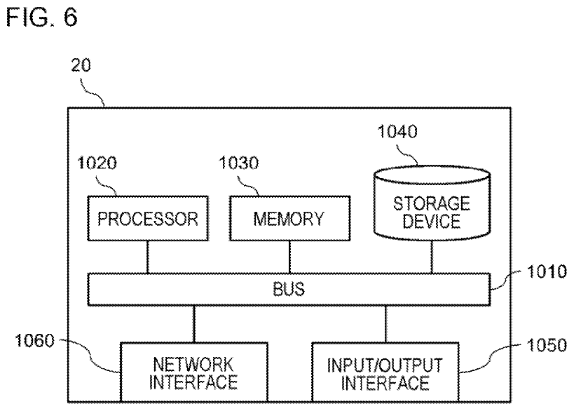

FIG. 6 is a diagram illustrating a hardware configuration example of the data management apparatus 20. The data management apparatus 20 includes a bus 1010, a processor 1020, a memory 1030, a storage device 1040, an input/output interface 1050, and a network interface 1060.

The bus 1010 is a data transmission path where the processor 1020, the memory 1030, the storage device 1040, the input/output interface 1050, and the network interface 1060 mutually transmit/receive data. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function (e.g., the data acquisition unit 210, the municipality information generation unit 220, the storage processing unit 230, and the data processing unit 240) of the data management apparatus 20. The processor 1020 reads each of the program modules onto the memory 1030, executes the read program module, and thereby achieves each function relevant to the program module. Further, the storage device 1040 also functions as the sensor location storage unit 222 and the data storage unit 232.

The input/output interface 1050 is an interface for connecting the data management apparatus 20 and various types of input/output devices with each other.

The network interface 1060 is an interface for connecting the data management apparatus 20 to a network. The network is, for example, a local area network (LAN) or a wide area network (WAN). A method for connection to a network by using the network interface 1060 may be wireless connection or wired connection. Then, the data management apparatus 20 is connected to the sensor apparatus 10 and the terminal 30 via the network interface 1060.

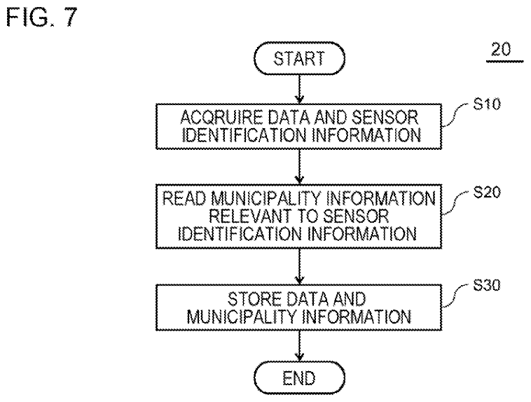

FIG. 7 is a flowchart illustrating a first example of processing executed by the data management apparatus 20. The present figure illustrates processing in which the data management apparatus 20 acquires data from the sensor apparatus 10 and stores the acquired data. The sensor apparatus 10 periodically (e.g., every one hour or every one day) transmits data generated by the image capture unit 104 and the sensor group 106 to the data management apparatus 20. At that time, the sensor apparatus 10 may change a frequency of transmitting an image generated by the image capture unit 104 and a frequency of transmitting data generated by the sensor group 106. The sensor apparatus 10 may set, for example, the former frequency to be larger than the latter frequency.

Then, the data acquisition unit 210 of the data management apparatus 20 acquires, from the sensor apparatus 10, pieces of data generated by the sensor apparatus 10 and information (sensor identification information, type information, and a generation time and date) added with these pieces of data (step S10). The municipality information generation unit 220 reads, from the sensor location storage unit 222, municipality information relevant to sensor identification information received by the data acquisition unit 210 (step S20). Then, the storage processing unit 230 stores, in the data storage unit 232, the data and the additional information (however, the sensor identification information may not necessarily be included) acquired by the data acquisition unit 210 in association with the municipality information read by the municipality information generation unit 220 (step S30).

Note that, in the example illustrated in the present figure, processing illustrated in step S20 may not necessarily be executed. In this case, the data processing unit 240 uses, when reading data of a municipality being a processing target from the data storage unit 232, the sensor location storage unit 222. In other words, when the data processing unit 240 acquires municipality information of a municipality being a processing target, the data processing unit reads, from the sensor location storage unit 222, sensor identification information associated with the municipality information. Then, the data processing unit 240 reads, from the data storage unit 232, data relevant to the read sensor identification information.

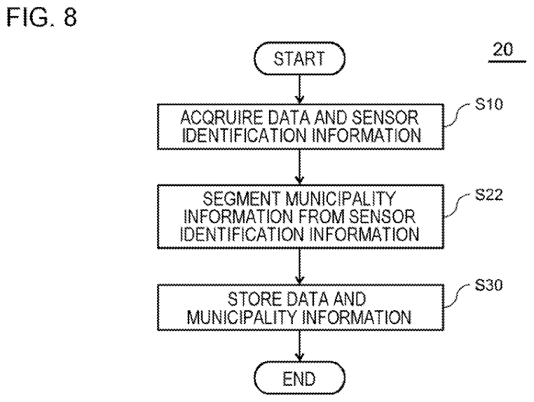

FIG. 8 is a flowchart illustrating a modification example of FIG. 7. In the example illustrated in the present figure, sensor identification information includes municipality information. Then, processing illustrated in the present figure is similar to the flowchart illustrated in FIG. 7 except that the municipality information generation unit 220 segments municipality information from sensor identification information and generates the municipality information (step S22).

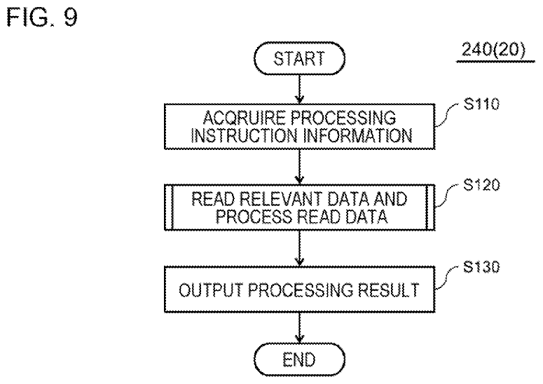

FIG. 9 is a flowchart illustrating a second example of processing executed by the data management apparatus 20. The present figure illustrates one example of processing executed by the data processing unit 240. The data processing unit 240 acquires processing instruction information (step S110). The processing instruction information includes information specifying data to be processed, information specifying a processing method, and information specifying a terminal 30 being an output destination. The data processing unit 240 reads, according to information included in the processing instruction information, information necessary for processing from the data storage unit 232. At that time, the data processing unit 240 reads, as necessary, data also from the open data storage apparatus 40. Then, the data processing unit 240 processes the read data according to information included in the instruction information (step S120). Then, the data processing unit 240 outputs a processing result to the terminal 30 (step S130).

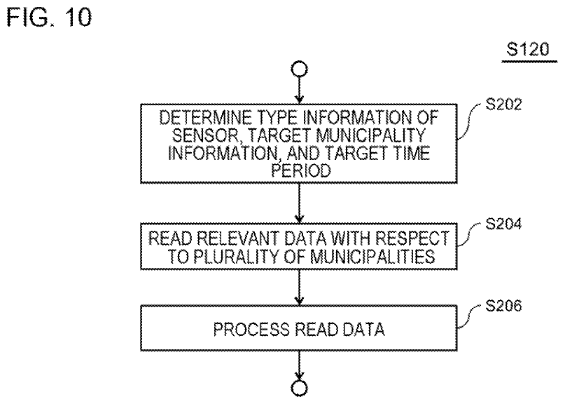

FIG. 10 is a flowchart illustrating a first example of step S120 in FIG. 9. In the example illustrated in the present figure, processing instruction information includes a processing method for data, type information of a sensor to be processed, municipality information being a processing target, and information indicating a generation time period of data to be processed. In other words, in the example illustrated in the present figure, the data processing unit 240 processes data generated, in a specific period, by a specific sensor in a specific community. Herein, there may be one piece of type information of a sensor, or may be a plurality of pieces of type information of sensors. Further, there may be one piece of municipality information, or may be a plurality of pieces of municipality information. Similarly, a generation time period may be one continuous period, or may be a plurality of periods separated from each other.

First, the data processing unit 240 determines, by using processing instruction information, type information of a sensor to be processed, municipality information to be processed, and information indicating a generation time period of data to be processed (step S202), and reads data relevant to pieces of the determined information from the data storage unit 232 (step S204). Then, the data processing unit 240 processes the read data according to processing instruction information, and generates information to be output (step S206).

When processing illustrated in the present figure is executed, the data processing unit 240 handles, as one data set, data generated by the same sensor in a plurality of communities (i.e., a plurality of municipalities), and thereby can output a result of processing the data set to the terminal 30. As one example, the data processing unit 240 handles, as one data set, data of a first sensor (e.g., any sensor included in the sensor group 106) in a community relevant to a municipality A and data of a first sensor in a community relevant to a municipality B, and thereby can also output a result of processing the data set to the terminal 30. Herein, a plurality of municipalities handled as one data set may be a continuous community (i.e., municipalities adjacent to each other), or may be communities separated from each other.

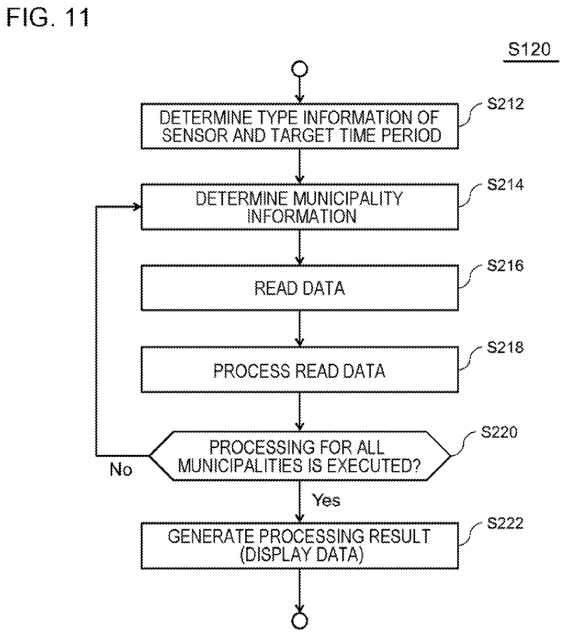

FIG. 11 is a flowchart illustrating a second example of step S120 in FIG. 9. In the example illustrated in the present figure, the data processing unit 240 processes a detection value of a sensor, and displays, with respect to each municipality, a result of the processing. This display example, for example, may be based on a map format, or may be based on a table format. And, processing instruction information includes a processing method for data, type information of a sensor, and information indicating a generation time period of data to be processed. Herein, the processing instruction information may include or may not include a plurality of pieces of municipality information to be processed.

First, the data processing unit 240 determines type information of a sensor to be processed and information indicating a generation time period of data to be processed. Herein, when a plurality of pieces of municipality information are included in processing instruction information, the data processing unit 240 limits target municipality information to these pieces of municipality information. On the other hand, when a plurality of pieces of municipality information are not included in processing instruction information, the data processing unit 240 sets target municipality information for all pieces of municipality information (step S212).

Then, the data processing unit 240 executes processing in step S216 and step S218 for all pieces of set municipality information (steps S214 and S222). First, the data processing unit 240 selects municipality information (step S214), and then reads data relevant to the selected municipality information and the type information determined in step S212 (step S216). Then, the data processing unit 240 processes the read data (step S218). In other words, the data processing unit 240 reads, from the data storage unit 232, data relevant to first type information and first municipality information, executes first processing, and outputs a result of the processing in association with the first municipality information. Further, the data processing unit 240 reads, from the data storage unit 232, data relevant to the first type information and second municipality information, executes the same first processing, and outputs a result of the processing in association with the second municipality information.

Then, the data processing unit 240 executes processing for all pieces of municipality information (step S220: Yes), and thereafter, generates display data as a processing result. The display data, as described above, may be based on a map format or may be based on a table format.

Note that, in both examples in FIGS. 10 and 11, the data processing unit 240 may process an image generated by the image capture unit 104 of the sensor apparatus 10. In this processing, the data processing unit 240 may determine at least one of the number of passersby in a location where the sensor apparatus 10 is installed, a congestion situation, and a direction of flow of a person. Herein, the data processing unit 240 may determine the number of passersby, based on each attribute, for example, based on at least one of each gender and each age group.

Further, the data processing unit 240 processes an image generated by the image capture unit 104, and thereby may determine a congestion situation of a road. Further, the data processing unit 240 may generate, based on a unit of a predetermined period (e.g., a unit of one week), a statistical value of clothes of a person passing through a road. The statistical value includes, for example, a ratio of persons wearing long sleeves/short sleeves, a ratio of persons wearing coats, and the like. Thereby, transition of clothes of persons can be determined based on a municipality unit.

Further, the data processing unit 240 may detect, instead of processing illustrated in FIGS. 10 and 11, a suspicious person by using an image generated by the image capture unit 104. The data processing unit 240 may determine, for example, a person exhibiting a previously-determined behavior as a suspicious person, and thereby output a determination result to the terminal 30.

As described above, according to the present example embodiment, a plurality of sensor apparatuses 10 are installed along a road. The data management apparatus 20 generates, by using sensor identification information, municipality information indicating a municipality that manages a location where the sensor apparatus 10 is installed. Then, the data management apparatus 20 stores data acquired from the sensor apparatus 10 in the data storage unit 232 in association with the municipality information. Therefore, data generated by the sensor apparatus 10 can be efficiently managed. Then, the data management apparatus 20 generates, based on a municipality unit, various pieces of data by using data stored in the data storage unit 232, and thereby can output the generated data to the terminal 30.

While with reference to the accompanying drawings, the example embodiment according to the present invention has been described, the example embodiment is exemplification of the present invention and various configurations other than the above-described configurations are employable.

Further, in a plurality of flowcharts used in the above-described description, a plurality of steps (processing) are described in order, but an execution order of steps to be executed according to each example embodiment is not limited to the described order. According to each example embodiment, an order of illustrated steps can be modified within an extent that there is no harm in context.

The whole or part of the example embodiment described above can be described as, but not limited to, the following supplementary notes.

1. A data management apparatus including:

a data acquisition unit that acquires data generated by a sensor apparatus installed along a road in association with sensor identification information capable of identifying the sensor apparatus;

a municipality information generation unit that generates, by using the sensor identification information, municipality information indicating a municipality that manages a location where the sensor apparatus is installed; and

a storage processing unit that stores the data in a storage unit in association with the municipality information.

2. The data management apparatus according to supplementary note 1, wherein

the municipality information generation unit generates the municipality information by using a sensor location storage unit that stores the sensor identification information in association with the municipality information.

3. The data management apparatus according to supplementary note 1, wherein

the sensor identification information includes the municipality information, and

the municipality information generation unit generates the municipality information from the sensor identification information.

4. The data management apparatus according to any one of supplementary notes 1 to 3, wherein

the sensor apparatus includes a plurality of types of sensors,

the data acquisition unit acquires the data generated by each of the plurality of types of sensors in association with type information indicating a type of the sensor, and

the storage processing unit stores, in the storage unit, the data in association with the type information of the sensor generating the data.

5. The data management apparatus according to supplementary note 4, further including

a data processing unit that reads, from the storage unit, the data relevant to first type information and first municipality information and the data relevant to the first type information and second municipality information, process the read data, and outputs a processing result.

6. The data management apparatus according to supplementary note 4, further including

a data processing unit that reads, from the storage unit, the data relevant to first type information and first municipality information, executes first processing, and outputs a result of the processing in association with the first municipality information, and also reading, from the storage unit, the data relevant to the first type information and second municipality information, executes the first processing, and outputs a result of the processing in association with the second municipality information.

7. The data management apparatus according to any one of supplementary notes 1 to 6, wherein

the data are an image acquired by capturing an image of a region including the road.

8. A sensor apparatus installed along a road, the sensor apparatus including:

at least one type of a sensor; and

a communication unit that transmits data generated by the sensor in association with municipality information indicating a municipality that manages a location where the data transmission apparatus is installed.

9. A data management method including:

by a computer,

acquiring data generated by a sensor apparatus installed along a road in association with sensor identification information capable of identifying the sensor apparatus;

generating, by using the sensor identification information, municipality information indicating a municipality that manages a location where the sensor apparatus is installed; and

storing the data in a storage unit in association with the municipality information.

10. The data management method according to supplementary note 9, further including,

by the computer,

generating the municipality information by using a sensor location storage unit that stores the sensor identification information in association with the municipality information.

11. The data management method according to supplementary note 9, wherein the sensor identification information includes the municipality information,

the data management method further including,

by the computer,

generating the municipality information from the sensor identification information.

12. The data management method according to any one of supplementary notes 9 to 11, wherein

the sensor apparatus includes a plurality of types of sensors,

the data management method further including:

by the computer,

acquiring the data generated by each of the plurality of types of sensors in association with type information indicating a type of the sensor; and

storing, in the storage unit, the data in association with the type information of the sensor generating the data.

13. The data management method according to supplementary note 12, further including,

by the computer

reading, from the storage unit, the data relevant to first type information and first municipality information and the data relevant to the first type information and second municipality information, processing the read data, and outputting a processing result.

14. The data management method according to supplementary note 12, further including,

by the computer,

reading, from the storage unit, the data relevant to first type information and first municipality information, executing first processing, and outputting a result of the processing in association with the first municipality information, and also reading, from the storage unit, the data relevant to the first type information and second municipality information, executing the first processing, and outputting a result of the processing in association with the second municipality information.

15. The data management method according to any one of supplementary notes 9 to 14, wherein

the data are an image acquired by capturing an image of a region including the road.

16. A program for causing a computer to include:

a function of acquiring data generated by a sensor apparatus installed along a road in association with sensor identification information capable of identifying the sensor apparatus;

a function of generating, by using the sensor identification information, municipality information indicating a municipality that manages a location where the sensor apparatus is installed; and

a function of storing the data in a storage unit in association with the municipality information.

17. The program according to supplementary note 16, for causing the computer to

generate the municipality information by using a sensor location storage unit that stores the sensor identification information in association with the municipality information.

18. The program according to supplementary note 16, wherein

the sensor identification information includes the municipality information,

the program for further causing the computer to

generate the municipality information from the sensor identification information.

19. The program according to any one of supplementary notes 16 to 18, wherein

the sensor apparatus includes a plurality of types of sensors,

the program for further causing the computer to execute processing of:

acquiring the data generated by each of the plurality of types of sensors in association with type information indicating a type of the sensor; and

storing, in the storage unit, the data in association with the type information of the sensor generating the data.

20. The program according to supplementary note 19, for further causing the computer to

read, from the storage unit, the data relevant to first type information and first municipality information and the data relevant to the first type information and second municipality information, process the read data, and output a processing result.

21. The program according to supplementary note 19, for further causing the computer to

read, from the storage unit, the data relevant to first type information and first municipality information, execute first processing, and output a result of the processing in association with the first municipality information, and also read, from the storage unit, the data relevant to the first type information and second municipality information, execute the first processing, and output a result of the processing in association with the second municipality information.

22. The program according to any one of supplementary notes 16 to 21, wherein

the data are an image acquired by capturing an image of a region including the road.

[Reference signs List]

| | |
|---|---|
| 10 | Sensor apparatus |
| 20 | Data management apparatus |
| 30 | Terminal |
| 40 | Open data storage apparatus |
| 102 | Light source |
| 104 | Image capture unit |
| 106 | Sensor group |
| 108 | Communication unit |
| 110 | Speaker |
| 112 | Display |
| 114 | Supporting pillar |
| 210 | Data acquisition unit |
| 220 | Municipality information generation unit |
| 222 | Sensor location storage unit |
| 230 | Storage processing unit |
| 232 | data storage unit |
| 240 | Data processing unit |

What is claimed is:

1. A data management apparatus comprising:
at least one memory storing instructions; and
at least one processor configured to execute the instructions to perform operations comprising:
acquiring data generated by a sensor apparatus installed along a road in association with sensor identification information capable of identifying the sensor apparatus;
generating, by using the sensor identification information, municipality information indicating a municipality that manages a location where the sensor apparatus is installed; and
storing the data in a storage in association with the municipality information.

2. The data management apparatus according to claim 1, wherein
the operations comprise generating the municipality information by using a sensor location storage that stores the sensor identification information in association with the municipality information.

3. The data management apparatus according to claim 1, wherein
the sensor identification information includes the municipality information, and
the operations comprise generating the municipality information from the sensor identification information.

4. The data management apparatus according to claim 1, wherein
the sensor apparatus includes a plurality of types of sensors,
the operations comprise:
acquiring the data generated by each of the plurality of types of sensors in association with type information indicating a type of the sensor; and
storing, in the storage, the data in association with the type information of the sensor generating the data.

5. The data management apparatus according to claim 4, wherein the operations comprise:
reading, from the storage, the data relevant to first type information and first municipality information and the data relevant to the first type information and second municipality information;
processing the read data; and
outputting a processing result.

6. The data management apparatus according to claim 4, wherein the operations comprise:
reading, from the storage, first data relevant to first type information and first municipality information and second data relevant to the first type information and second municipality information;
executing first processing on the first data and the second data; and
outputting a result of the processing in association with the first municipality information and a result of the processing in association with the second municipality information.

7. The data management apparatus according to claim 1, wherein
the data are an image acquired by capturing an image of a region including the road.

8. A sensor apparatus installed along a road, the sensor apparatus comprising:
at least one type of a sensor; and
a communication interface that transmits data generated by the sensor in association with municipality information indicating a municipality that manages a location where the sensor apparatus is installed.

9. A data management method comprising:
by a computer,
acquiring data generated by a sensor apparatus installed along a road in association with sensor identification information capable of identifying the sensor apparatus;
generating, by using the sensor identification information, municipality information indicating a municipality that manages a location where the sensor apparatus is installed; and
storing the data in a storage in association with the municipality information.

10. (canceled)
